(19) United States
(12) Patent Application Publication
(10) Pub. No.: US 2021/0301880 A1
(43) Pub. Date: Sep. 30, 2021

(54) UNIVERSAL JOINT

(71) Applicant: Hong Ann Tool Industries Co., Ltd., Taichung (TW)

(72) Inventor: Cheng-Wei SU, Taichung City (TW)

(21) Appl. No.: 16/828,103

(22) Filed: Mar. 24, 2020

(51) Int. Cl. F16D 3/38; F16D 3/24; F16D 3/72

(52) U.S. Cl. CPC F16D 3/38; F16D 3/72; F16D 3/24

(57) ABSTRACT

A universal joint includes a first joining structure and a second joining structure movably coupled to each other. The first and the second joining structures are movable relative to each other to an aligned position and an inclined position. The first and the second joining structures include a resilient member disposed therebetween. The resilient member has a first end retained on the first joining structure and a second end retained on the second joining structure.

### BACKGROUND OF THE INVENTION

### 1. Field of the Invention

The present invention relates to a socket adaptor and, particularly, to a universal joint adaptor.

### 2. Description of the Related Art

TW Pat. No. 1619890 relates to a socket adaptor. The socket adaptor includes a first member and a second member pivotally coupled to the first member. The first member has a first end and a second end on opposite ends. A power tool is adapted to couple to the first end of the first member to drive the socket adaptor. The second end of the first member defines a receiving hole. The second member has a first end and a second end on opposite ends. The first end is spherical and is pivotally engaged in the receiving hole. An object to be driven is adapted to couple to the second end of the second member. The socket adaptor also includes a limiting member disposed between the first and the second members and a magnetic member disposed at the second end of the second member.

The problem is when the socket adaptor is driven at a high speed, the second member withstands a large centrifugal force and is shaken.

The present invention is, therefore, intended to obviate or at least alleviate the problems encountered in the prior art.

### SUMMARY OF THE INVENTION

According to the present invention, a universal joint includes a first joining structure and a second joining structure. The first and the second joining structures are movably coupled to each other. The first and the second joining structures are movable relative to each other to an aligned position and an inclined position. The first and the second joining structures include a resilient member disposed therebetween. The resilient member has a first end retained on the first joining structure and a second end retained on the second joining structure.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the public generally, and especially the scientists, engineers and practitioners in the art who are not familiar with patent or legal terms or phraseology, to determine quickly from a cursory inspection the nature and essence of the technical disclosure. The abstract is neither intended to define the invention, which is measured by the claims, nor is it intended to be limiting as to the scope of the invention in any way.

Other objectives, advantages, and new features of the present invention will become apparent from the following detailed description of the invention when considered in conjunction with the accompanied drawings.

### BRIEF DESCRIPTION OF THE DRAWINGS

FIG. 1 is a perspective view of a universal joint in accordance with a first embodiment of the present invention.

FIG. 2 is an exploded perspective view of the universal joint of FIG. 1.

FIG. 3 is a cross-sectional view of the universal joint of FIG. 1.

FIG. 4 is a perspective view of a universal joint in accordance with a second embodiment of the present invention.

FIG. 5 is an exploded perspective view of the universal joint of FIG. 4.

FIG. 6 is a cross-sectional view of the universal joint of FIG. 4.

FIG. 7 is a perspective view of a universal joint in accordance with a third embodiment of the present invention.

FIG. 8 is an exploded perspective view of the universal joint of FIG. 7.

FIG. 9 is a cross-sectional view of the universal joint of FIG. 7.

FIG. 10 is a perspective view of a universal joint in accordance with a fourth embodiment of the present invention.

FIG. 11 is an exploded perspective view of the universal joint of FIG. 10.

FIG. 12 is a cross-sectional view of the universal joint of FIG. 10.

FIG. 13 is a perspective view of a universal joint in accordance with a fifth embodiment of the present invention.

FIG. 14 is an exploded perspective view of the universal joint of FIG. 13.

FIG. 15 is a cross-sectional view of the universal joint of FIG. 13.

### DETAILED DESCRIPTION OF THE INVENTION

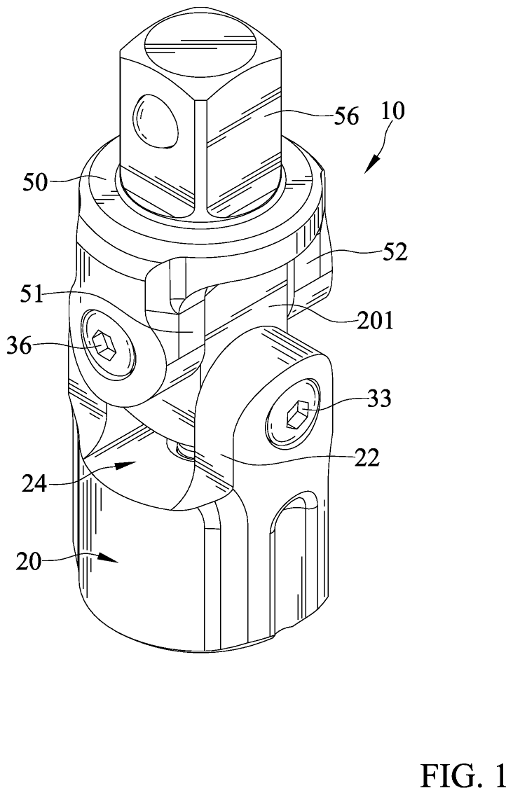

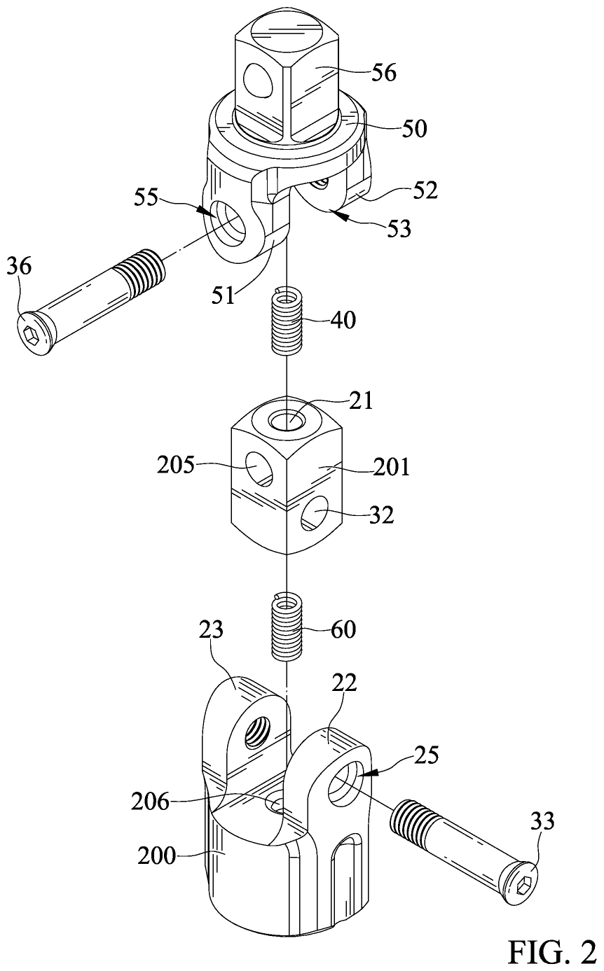

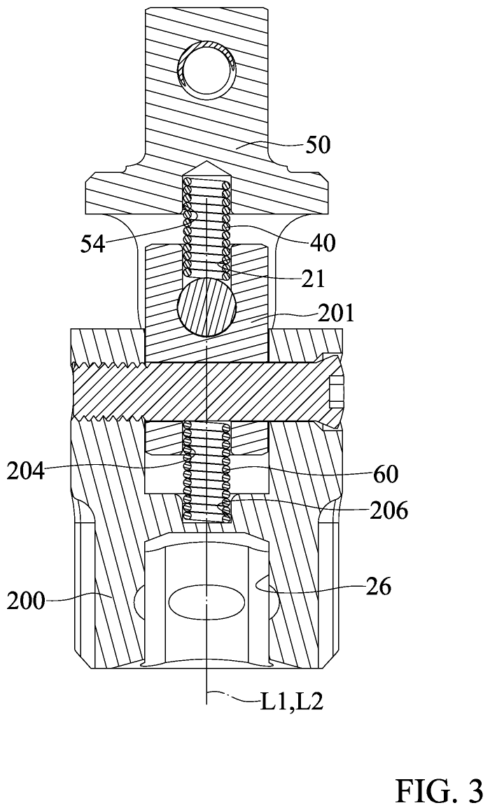

FIGS. 1 through 3 show a universal joint 10 in accordance with a first embodiment of the present invention.

The universal joint 10 includes a joining structure 20 and a joining structure 50. The joining structures 20 and 50 are configured to allow external objects to engage with the universal joint 10. The joining structures 20 and 50 are movably coupled to each other. The joining structures 20 and 50 are movable relative to each other to an aligned position and an inclined position. The universal joint 10 is adapted to be rotatably driven. When the universal joint 10 is rotatably driven and the joining structures 20 and 50 are aligned, the joining structure 20 rotates about an axis L1, the joining structure 50 rotates about an axis L2, and the axes L1 and L2 are aligned.

The joining structure 20 has an adapting portion 26 configured to allow an external object to engage with the universal joint 10. The adapting portion 26 defines a hole. The joining structure 50 has a second adapting portion 56 configured to allow an external object to engage with the universal joint 10. The adapting portion 56 is in a form of a projection. The projection is polygonal in cross section. The projection has a square cross-section as shown in the figures, but not limited thereto. The adapting portion 56 also has a detent disposed thereon. The detent dome-shaped as shown in the figures.

The joining structure 20 has two members 200 and 201 movably coupled to each other. The two members 200 and 201 are movable relative to each other to an aligned position and an inclined position. The joining structure 50 is coupled to the member 201. The adapting portion 26 in on member 200. The two members 200 and 201 are pivotally movable about a pivot 33. The member 200 has at least one lug ear. The at least one lug ear and the member 201 are linked by the pivot 33. The member 200 has a lug ear 22, a lug ear 23, and a space 24 between the lug ears 22 and 23. The lug ear 22 defines an orifice 25 and the lug ear 23 defines an orifice corresponding to the orifice 25. The member 201 of the joining structure 20 defines an orifice 205 extending therethrough. The pivot 33 links the lug ears 22 and 23 and the member 201 by inserting into the orifice 25, the orifice 205, and the orifice of the lug ear 23 sequentially. The two members 200 and 201 include a resilient member 60 disposed therebetween. The resilient member 60 is a coil spring. The resilient member 60 has one end retained in a hole 204 defined in the member 201 and another end retained in a hole 206 defined in the member 200.

The joining structures 20 and 50 are pivotally movable about a pivot 36. The pivots 36 and 33 have different orientations. The joining structure 50 has at least one lug ear. The at least one lug ear and the member 201 are linked by the pivot 36. The joining structure 50 has a lug ear 51, a lug ear 52, and a space 53 between the lug ears 51 and 52. An end of the member 201 is disposed between the lug ears 51 and 52. The lug ear 51 defines an orifice 55 and the lug ear 23 defines an orifice corresponding to the orifice 55. The member 201 of the joining structure 20 defines an orifice 205 extending therethrough. The pivot 36 links the lug ears 51 and 52 and the member 201 of the joining structures 20 by inserting into the orifice 55, the orifice 205, and the orifice of the lug ear 52 sequentially. The joining structures 20 and 50 include a resilient member 40 disposed therebetween. The resilient member 40 is configured to prevent the joining structures 20 and 50 from shaking when the universal joint is driven at a high speed. The joining structure 50 is urged by the resilient member 40. The resilient member 40 is a coil spring. The resilient member 40 has a first end retained on the joining structure 20 and a second end retained on the joining structure 50. The resilient member 40 includes the first end retained in a hole 21 defined in the joining structure 20 and the second end retained in a hole 54 defined in the joining structure 50. The hole 21 is aligned with the hole 54.

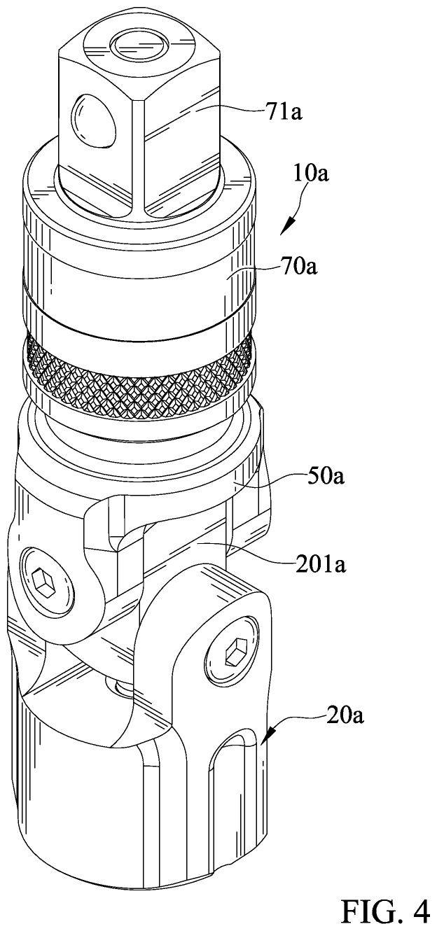

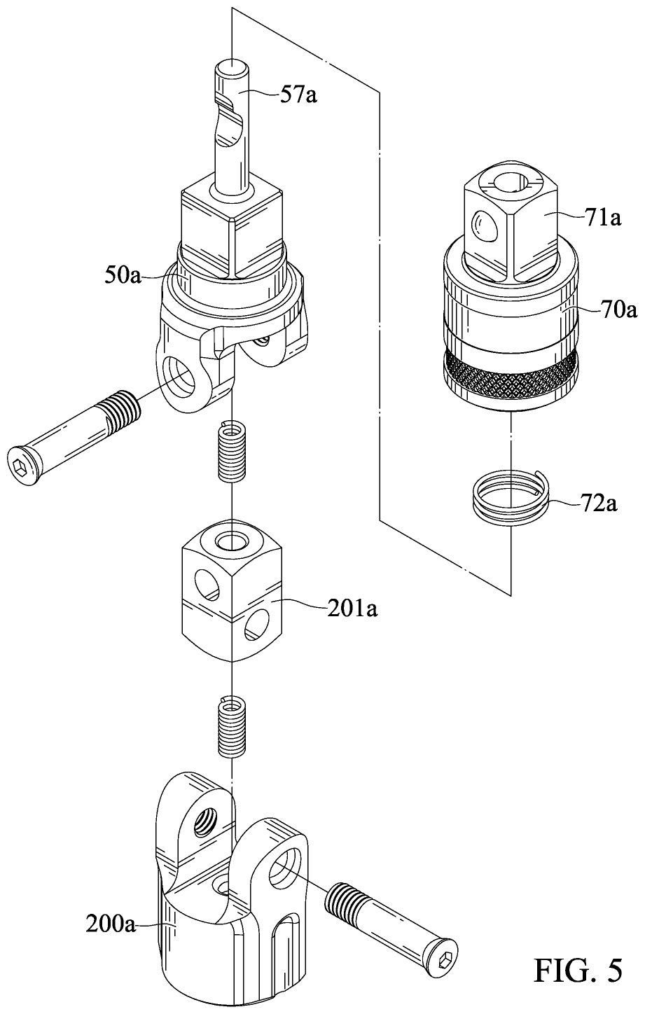

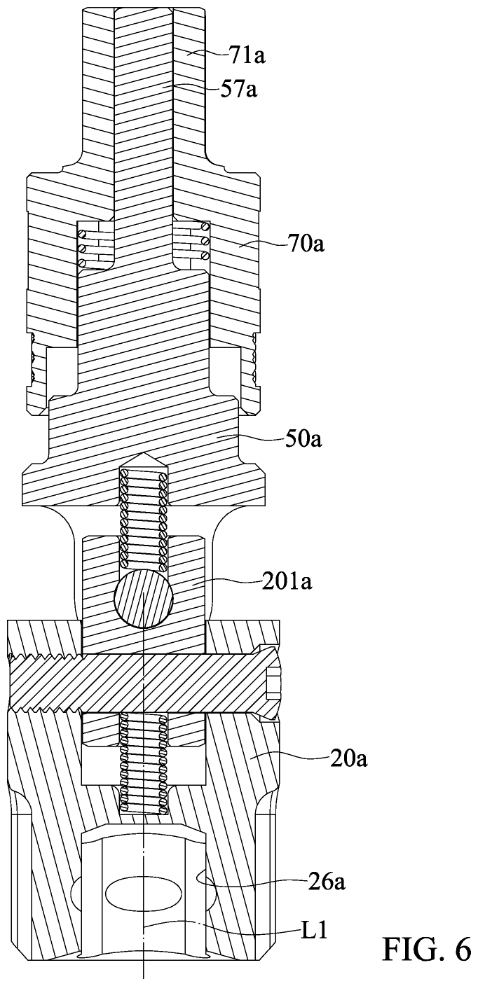

FIGS. 4 through 6 show a universal joint 10a in accordance with a second embodiment of the present invention, and the same numbers are used to correlate similar components of the first embodiment, but bearing a letter a. The second embodiment is similar to the first embodiment. A joining structure 20a and a joining structure 50a are movably coupled to each other. The joining structure 20a has two members 200a and 201a movably coupled to each other. The joining structure 20 has an adapting portion 26a configured to allow an external object to engage with the universal joint 10a. The adapting portions 26 defines a hole.

The second embodiment differentiates from the first embodiment in that it includes an adapter 70a with an adapting portion 71a. The adapting portion 71a cooperates with an adapting portion of the joining structure 50a to allow an external object to engage with the universal joint 10a. The adapter 70a is movably coupled to the adapting portion of the joining structure 50a. The adapter 70a is urged by a resilient member 72a. The resilient member 72a is retained between the adapter 70a and the adapting portion of the joining structure 50a. The adapting portion of the joining structure 50a includes a shaft 57a with a recess having a shallow portion and a deep portion. The adapter 70a is hollow and the shaft 57a is inserted in the adapter 70a.

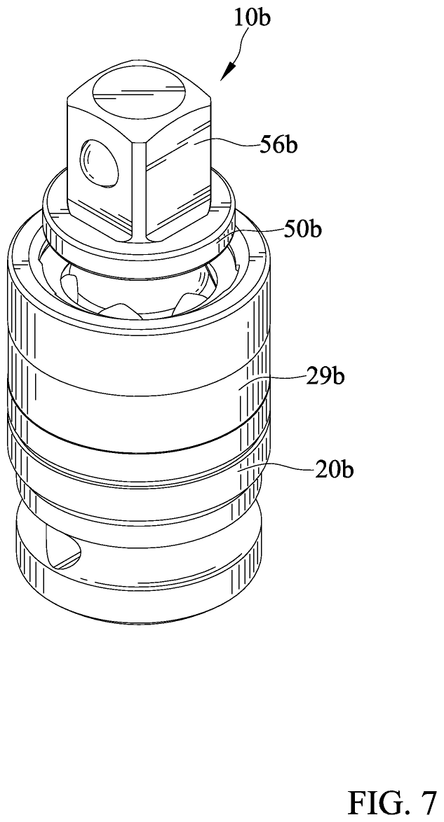

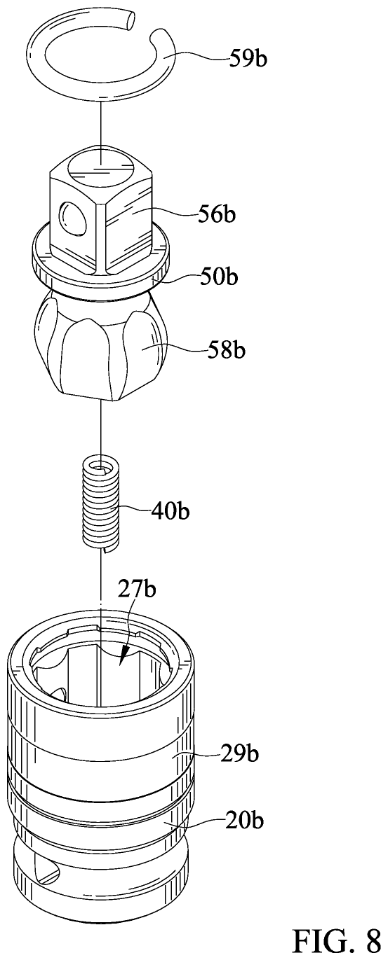

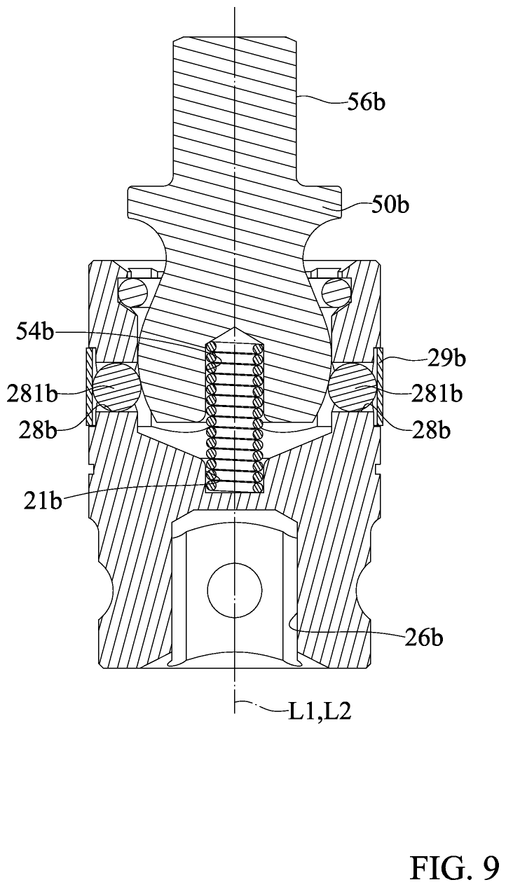

FIGS. 7 through 9 show a universal joint 10b in accordance with a third embodiment of the present invention, and the same numbers are used to correlate similar components of the first embodiment, but bearing a letter b. The third embodiment is similar to the first embodiment. A joining structure 20b and a joining structure 50b are movably coupled to each other. The joining structures 20b and 50b include a resilient member 40b disposed therebetween. The joining structure 20b has adapting portions 26b configured to allow an external object to engage with the universal joint 10b. The adapting portions 26b defines a hole. The joining structure 50b has adapting portions 56b configured to allow an external object to engage with the universal joint 10b.

The third embodiment differentiates from the first embodiment in that the joining structure 20b defines a compartment 27b which has an enclosed circumference. A hole 21b extends to the compartment 27b. The compartment 27b has a non-circular cross section. Further, an end 58b of the joining structure 50b is retained in the compartment 27b. The end 58b is a ball end. A hole 54b defines an opening on the end 58b. Further, a retainer 59b prevents the end 58b of the joining structure 50b from falling outside the compartment 27b. The retainer 59b is fit in a recess which is defined by the joining structure 20b and extends radially from the compartment 27b. The retainer 59b is in a form of a C-ring. Further, a positioning device keeps the joining structure 50b in position. The positioning device includes at least one detent 281b disposed in an orifice 28b which is defined by the joining structure 20b. The orifice 28b extends radially from the compartment 27b. The orifice 28b extends through the joining structure 20b. Moreover, the positioning device includes a resilient retainer 29b preventing the at least one detent 281b from falling outside the joining structure 20b. The at least one detent 281b abuts an outer periphery of the end of the joining structure 50b and an inner periphery of the retainer 29b.

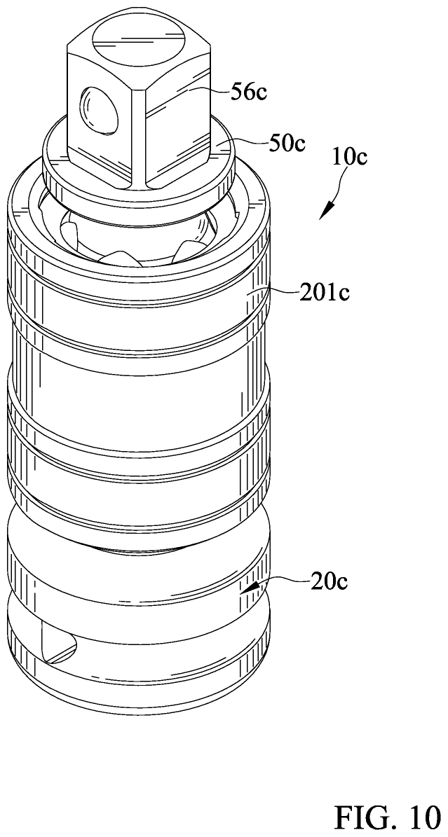

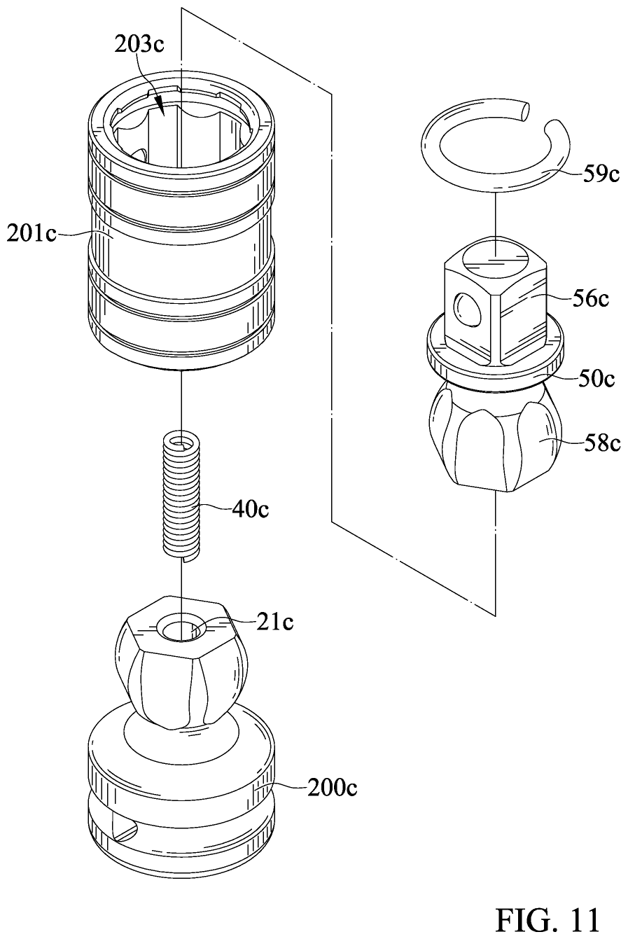

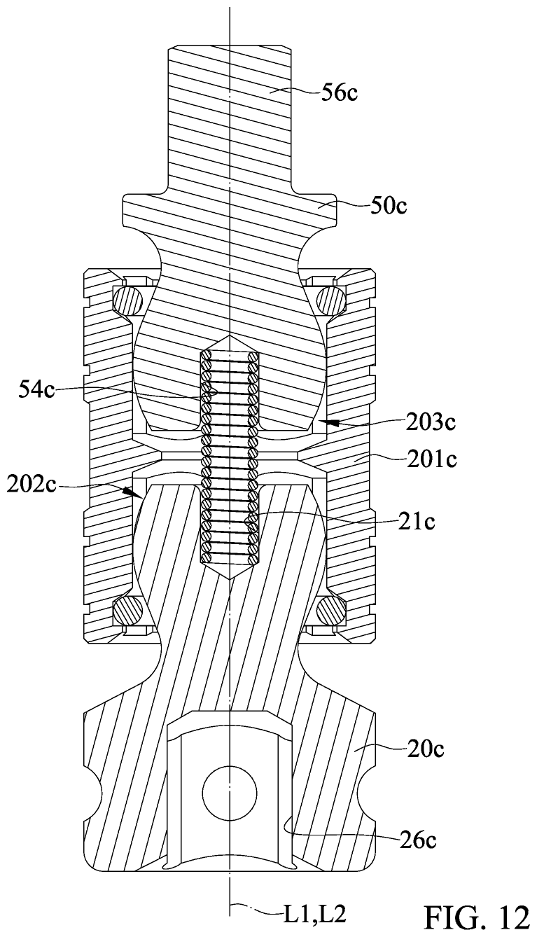

FIGS. 10 through 12 show a universal joint 10c in accordance with a fourth embodiment of the present invention, but bearing a letter c. The fourth embodiment is similar to the first embodiment. A joining structure 20c and a joining structure 50c are movably coupled to each other. The joining structures 20c and 50c include a resilient member 40c disposed therebetween. The joining structure 20 has adapting portions 26c and 56c configured to allow an external object to engage with the universal joint 10b. The joining structure 20c has two members 200c and 201c movably coupled to each other. The two members 200c and 201c are movable relative to each other to an aligned position and an inclined position. The joining structure 50c is coupled to the member 201c. The adapting portion 26c is on the member 200c. The adapting portions 26c defines a hole.

The fourth embodiment differentiates from the first embodiment in that the member 201c defines a compartment 202c which has an enclosed circumference and a compartment 203c which has an enclosed circumference. The compartment 203c has a non-circular cross section. An end of the joining structure 50c is retained in the compartment 203c. The end of the joining structure 50c is a ball end. An end of the member 200c is retained in the second compartment 202c. The end of the member 200c is a ball end. A hole 21c defines an opening on the end of the member 200c. Further, a retainer 59c prevents an end 58c of the joining structure 50c from falling outside the compartment 203c. The retainer 59c is fit in a recess which is defined by the joining structure 50c and extends radially from the compartment 203c. The retainer 59b is in a form of a C-ring.

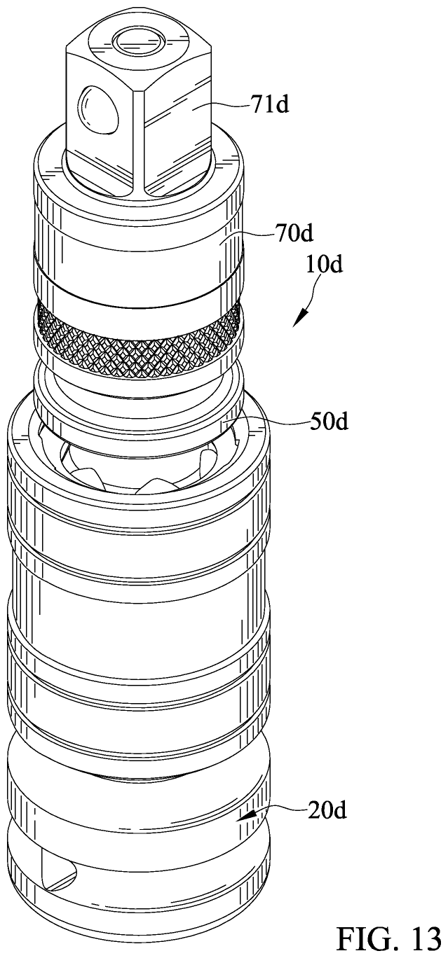

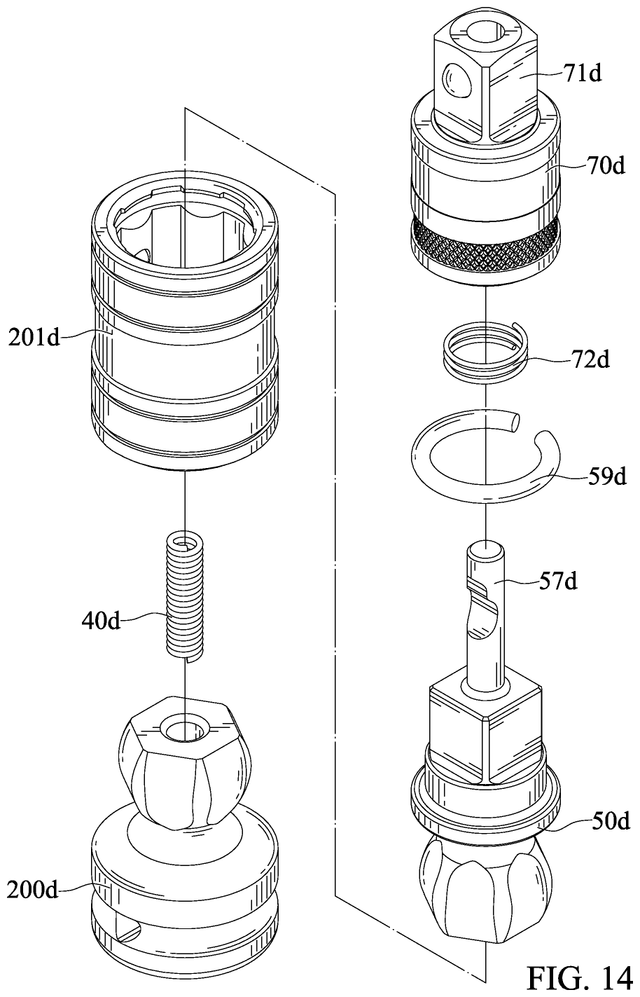

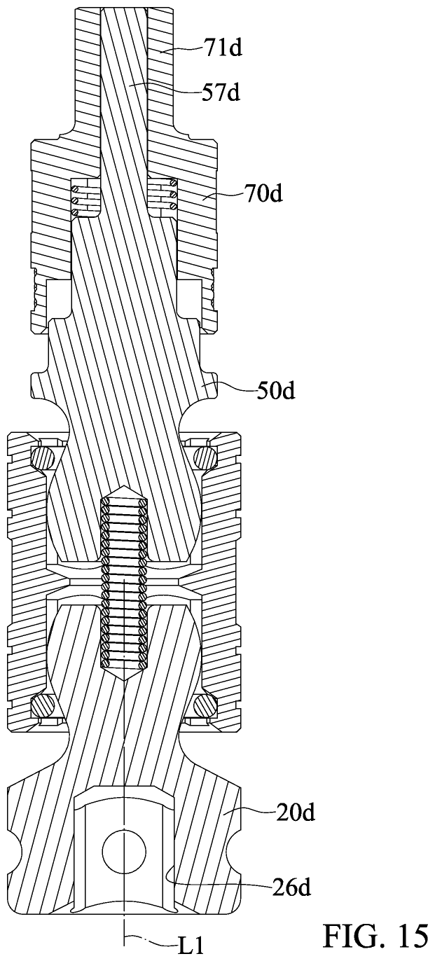

FIGS. 13 through 15 show a universal joint 10d in accordance with a fifth embodiment of the present invention in accordance with a second embodiment of the present invention, and the same numbers are used to correlate similar components of the fourth embodiment, but bearing a letter d. The fifth embodiment is similar to the fourth embodiment. A joining structure 20d and a joining structure 50d are movably coupled to each other. The joining structure 20a has two members 200a and 201a movably coupled to each other. The joining structures 20d and 50d include a resilient member 40d disposed therebetween. The joining structure 20d has two members 200d and 201d movably coupled to each other. The two members 200d and 201d are movable relative to each other to an aligned position and an inclined position. The joining structure 20 has an adapting portion 26d configured to allow an external object to engage with the universal joint 10a. The adapting portions 26d defines a hole.

The fifth embodiment differentiates from the fourth embodiment in that it includes an adapter 70d with an adapting portion 71d. The adapting portion 71d cooperates with an adapting portion of the joining structure 50d to allow an external object to engage with the universal joint 10d. The adapter 70d is movably coupled to the adapting portion of the joining structure 50d. The adapter 70d is urged by a resilient member 72d. The resilient member 72d is retained between the adapter 70d and the adapting portion of the joining structure 50d. The adapting portion of the joining structure 50d includes a shaft 57d with a recess having a shallow portion and a deep portion. The adapter 70d is hollow and the shaft 57d is inserted in the adapter 70a. Further, a retainer 59d prevents an end of the joining structure 50d from falling outside a compartment. The retainer 59d is fit in a recess which is defined by the joining structure 50d and extends radially from the compartment. The retainer 59b is in a form of a C-ring.

In view of the foregoing, the joining structures 20, 20a, 20b, 20c, 20d, 50, 50a, 50b, 50c, and 50d are movable relative to each other to an aligned position and an inclined position. The joining structures 20, 20a, 20b, 20c, 20d) have adapting portions 26, 26a, 26c, and 26d configured to allow an external object to engage with the universal joints 10, 10a, 10b, 10c, and 10d. The joining structures 50, 50a, 50b, 50c, and 50d have adapting portions 56, 56b, and 56c configured to allow an external object to engage with the universal joints 10, 10a, 10b, 10c, and 10d. The resilient members 40, 40b, 40c, and 40d is stably retained between the joining structures 20, 20a, 20b, 20c, 20d, 50, 50a, 50b, 50c, and 50d. The resilient members 40, 40b, 40c, and 40d are configured to prevent the joining structures 20, 20a, 20b, 20c, 20d, 50, 50a, 50b, 50c, and 50d from shaking when the universal joint is driven at a high speed.

The foregoing is merely illustrative of the principles of this invention and various modifications can be made by those skilled in the art without departing from the scope and spirit of the invention.

What is claimed is:

1. A universal joint comprising:
a first joining structure and a second joining structure, wherein the first and the second joining structures are movably coupled to each other, wherein the first and the second joining structures are movable relative to each other to an aligned position and an inclined position, wherein the first and the second joining structures include a first resilient member disposed therebetween, and wherein the first resilient member has a first end retained on the first joining structure and a second end retained on the second joining structure.

2. The universal joint as claimed in claim 1, wherein the first resilient member includes the first end retained in a first hole defined in the first joining structure, wherein the first resilient member includes the second end retained in a second hole defined in the second joining structure, and wherein the first hole is aligned with the second hole.

3. The universal joint as claimed in claim 1, wherein the first resilient member is a coil spring.

4. The universal joint as claimed in claim 1, wherein the first joining structure has a first adapting portion configured to allow an external object to engage with the universal joint, and wherein the second joining structure has a second adapting portion configured to allow an external object to engage with the universal joint.

5. The universal joint as claimed in claim 4, wherein the first joining structure has two members movably coupled to each other, wherein the two members are movable relative to each other to an aligned position and an inclined position, wherein the second joining structure is coupled to one of the two members, and wherein the first adapting portion is on the other of the two members.

6. The universal joint as claimed in claim 5, wherein the two members include a second resilient member disposed therebetween, and wherein the second resilient member has one end retained in a first hole defined in one of the two members and another end retained in a second hole defined in the other of the two members.

7. The universal joint as claimed in claim 6, wherein the first and the second joining structures are pivotally movable about a first pivot, wherein the second joining structure has at least one lug ear, and wherein the at least one lug ear and one of the two members of the first joining structure are linked by the first pivot.

8. The universal joint as claimed in claim 7, wherein the two members are pivotally movable about a second pivot, wherein the first and the second pivots have different orientations, wherein the other of the two members has at least one lug ear, and wherein the at least one lug ear and one of the two members are linked by the second pivot.

9. The universal joint as claimed in claim 4, wherein the first joining structure defines a compartment and the second joining structure includes an end retained in the compartment, wherein the end of the second joining structure is a ball end, wherein the first hole extends to the compartment, and wherein the second hole defines an opening on the end.

10. The universal joint as claimed in claim 9 further comprising a positioning device keeping the second joining structure in position, wherein the first joining structure defines an orifice extending radially from the compartment and the positioning device includes at least one detent disposed in the orifice, wherein the positioning device includes a resilient retainer preventing the at least one detent from falling outside the first joining structure, and wherein the at least one detent abuts an outer periphery of the end of the second joining structure and an inner periphery of the retainer.

11. The universal joint as claimed in claim 5, wherein one of the two members defines a first compartment and the second joining structure includes an end retained in the first compartment, wherein one of the two members defines a second compartment and the other of the two members includes an end retained in the second compartment, wherein the end of the second joining structure is a ball end, wherein the end of the other of the two members is a ball end, wherein the first hole defines an opening on the end of the other of the two members, and wherein the second hole defines an opening on the end of the second joining structure.

12. The universal joint as claimed in claim 4 further comprising an adapter cooperating with the second adapting portion to allow an external object to engage with the universal joint, wherein the adapter is movably coupled to the second adapting portion, wherein the adapter is urged by a resilient member, and wherein the resilient member is retained between the adapter and the second adapting portion.

13. The universal joint as claimed in claim 12, wherein the second adapting portion includes a shaft with a recess having a shallow portion and a deep portion, and wherein the adapter is hollow and the shaft is inserted in the adapter.
